(19) United States
(12) Patent Application Publication
(10) Pub. No.: US 2026/0356321 A1
(43) Pub. Date: Nov. 12, 2026

(54) BELT RETRACTOR WITH A TENSIONING DEVICE

(71) Applicant: Autoliv Development AB, Vargarda (SE)

(72) Inventors: Marko ANUSIC, Hamburg (DE); Thomas KUBBE, Kaltenkirchen (DE); Roman ROMAKER, Elmshorn (DE)

(21) Appl. No.: 19/130,794

(22) PCT Filed: Nov. 10, 2023
(86) PCT No.: PCT/EP2023/081416

§ 371 Date: May 16, 2025

(30) Foreign Application Priority Data
Nov. 18, 2022 (DE) 10 2022 130 542.2

(51) Int. Cl. B60R 22/34; B60R 22/28; B60R 22/347

(52) U.S. Cl. CPC B60R 22/3413; B60R 22/347; B60R 2022/287; B60R 2022/3402

(57) ABSTRACT

A belt retractor having a tensioning device having a frame which can be fixed to the vehicle and has two frame legs arranged parallel to one another, each with a bearing opening, and a belt shaft which is arranged between frame legs and is rotatably mounted in the bearing openings of the frame legs, and a tensioner drive wheel which is connected to the belt shaft in a rotationally fixed manner or can be connected via a clutch, a pot-like housing with a substantially constant wall thickness is fastened to one of the frame legs on the side facing away from the other frame leg, in which the tensioner drive wheel is arranged, wherein the pot-like housing has an opening with a toothing, and the pot-like housing has, at least in portions, a thickening in the region of the edge of the opening and the toothing.

The present invention relates to a belt retractor with a tensioning device, having the features of the preamble of claim 1.

Belt retractors of this generic type are used in safety belt devices for motor vehicles and are used to wind up one end of a safety belt of the safety belt device. The belt retractor itself has a frame for fastening to the vehicle, which has two parallel, opposite frame legs, each with a bearing opening, in which a belt shaft is rotatably mounted, on which in turn the safety belt can be wound up with one end. The belt shaft is pre-tensioned in the winding direction of the safety belt by means of a mainspring supported on the frame. Furthermore, the belt shaft can be blocked by means of a blocking device which can be controlled by a sensor device which is sensitive to vehicle acceleration and/or a sensor device which is sensitive to belt webbing extension acceleration, when a predetermined vehicle deceleration and/or belt webbing extension acceleration is exceeded in the extension direction of the safety belt. The blocking device is formed by a blocking pawl pivotally mounted on the belt shaft or on a part connected to it in a rotationally fixed manner, which engages a frame-fixed blocking toothing to block the belt shaft.

Furthermore, the generic belt retractor has a tensioning device which, when activated, drives the belt shaft in the winding direction to tension the safety belt. The tensioning device can be reversible, e.g., with an electric motor that can be activated repeatedly, or irreversible with a pyrotechnic drive that can be activated once. The tensioning device has a tensioner drive wheel which is connected to the belt shaft in a rotationally fixed manner or can be connected to it via a switchable clutch. Furthermore, a tensioner housing is provided, which covers the tensioning device at least in the region of the drive wheel and can be the carrier of further components of the belt retractor and the tensioning device.

Such a belt retractor is known from DE 10 2008 059 387A1. The tensioner housing is designed as a pot-like housing which is fastened to the outer side of a frame leg of the frame of the belt retractor and has a circular opening with a toothing into which the blocking pawl engages to block the belt shaft. The toothing is arranged in the annular edge of the opening and is formed by radially inwardly directed teeth. The belt shaft is made up of two parts: a belt shaft body and a profile head, which are connected to each other in a rotationally fixed manner via a torsion bar. The torsion bar forms a force limiting device and connects the profile head and the belt shaft body to a torsionally fixed connection up to its plastic deformation limit. The belt shaft body is used to wind up the safety belt, while the profile head carries the blocking pawl and extends through the opening of the tensioning device housing. The blocking pawl, which is pivotally mounted on the profile head, is arranged in such a way that it is in an overlapping arrangement with the toothing of the opening, so that the blocking pawl engages in the toothing when pivoted out and blocks the belt shaft in the extension direction. The torsion bar forms a force limiting device and, in the event of a blocked profile head, enables force limited belt webbing extension to limit the occupant load during the accident. The profile head also serves to hold the tensioner drive wheel, which is arranged in the pot-like housing, so that the tensioning device drives the belt shaft in the winding direction when activated via the profile head.

The pot-like housing of the tensioning device therefore serves not only to cover the tensioner drive wheel but also to absorb and transmit the restraining forces that occur when the occupant is restrained and must therefore be designed to be dimensionally stable and load-bearing. A particularly critical point is the toothing, since in the event of a restraining event, it has to absorb particularly large forces locally in the region of the engaging blocking pawl, which leads to particularly high material stresses in the pot-like housing.

Against this background, the object of the invention is to provide a generic belt retractor with a tensioning device in which the load absorption in the case of restraint is improved by the housing and the resulting maximum material stresses in the housing are reduced.

According to the basic idea of the invention, it is proposed that the pot-like housing has, at least in portions, a thickening in the region of the edge of the opening and the toothing, in which thickening the toothing is arranged, wherein the thickening is formed by a protrusion on one side which is directed towards the frame leg to which the pot-like housing is fastened, and the side of the edge of the opening and the toothing facing away from the frame leg is formed by a flat surface.

By thickening the housing in the edge region of the opening, where the toothing is also provided, the housing is specifically stiffened in the region in which the blocking pawl engages in the event of restraining. On the one hand, the thickening increases the contact surface for the blocking pawl and, on the other hand, the deformation resistance of the housing in this region is increased due to the increased thickness. The thickening is deliberately designed in such a way that it is formed by a raised portion towards the frame leg, i.e., towards the inside of the housing, while the outer side of the housing is formed by a flat surface in the region of the edge region of the opening and the toothing. The pot-like housing is thus more dimensionally stable in the region of the toothing without increasing the required installation space. The proposed arrangement of the protrusion and the flat surface of the outer side deliberately use the installation space inside the housing to stiffen the housing. Furthermore, this enables cost-effective production of the housing as the thickening only needs to be formed on one side of the housing. Furthermore, the housing can be made more rigid for the forces acting in the case of restraining, since the proposed arrangement of the protrusion shifts the force vector acting on the toothing and the edge of the opening towards the inside of the pot-like housing when restraining due to the forces exerted by the blocking pawl. As a result, when the blocking pawl engages, a torque is exerted on the edge of the opening in the housing, which pushes the edge of the opening inwards and thus counteracts any expansion of the housing. During this deformation of the edge of the housing, the housing is additionally stiffened and stabilized by the compressive stresses that arise in the protrusion. Overall, a considerably stiffer housing can be realized with simple means in relation to the forces acting in the event of a restraint.

It is further proposed that the thickness of the toothing in the direction of the axis of rotation of the belt shaft corresponds to the thickness of the thickening in the direction of the axis of rotation of the belt shaft. This means that the entire width of the thickening is used to form the toothing and thus to transfer the load during engagement of the blocking pawl, which in turn reduces material stresses to a maximum. Furthermore, the toothing can be produced particularly easily in a punching or rolling process by deforming the entire edge region of the thickening to form the toothing.

It is further proposed that the thickening is dimensioned such that the center of the toothing that is arranged perpendicularly to the axis of rotation of the belt shaft and extends through the thickening and the center of the blocking pawl that is arranged perpendicularly to the axis of rotation of the belt shaft lie in one plane. Due to the proposed dimensioning of the thickening and the blocking pawl aligned with it, both the blocking pawl itself and the housing in the region of the thickening are loaded as evenly and symmetrically as possible when the blocking pawl engages the toothing, so that the maximum material stresses in the housing and the blocking pawl can also be reduced. Furthermore, this can reduce possible tilting moments acting on the blocking pawl when engaging the toothing.

It is further proposed that the housing has a thickness in the region of the thickening which is at least 20 percent and at most 80 percent greater than the wall thickness of the pot-like housing. The proposed design of the thickening allows, on the one hand, sufficient stiffening of the housing in the region of the toothing for the load case and, on the other hand, the shaping of the thickening during the production process of the housing, e.g., by a multiple forming process or an injection molding process, without the need to add additional material.

It is further proposed that the thickening in the radial direction is greater than the toothing depth of the toothing. This means that the toothing is completely arranged in the thickening, so that the reaction forces to be absorbed when restraining the occupant are completely absorbed by the housing in the region of the proposed thickening. The housing is thus thickened over the entire radial extent of the toothing.

It is further proposed that the thickness of the thickening decreases outwards in the radial direction. This means that the housing is thicker in the region of the tooth tips of the toothing and therefore more dimensionally stable than in the tooth base of the toothing. This is advantageous because the toothing forms an enlarged force transmission surface for the engaging blocking pawl in the region of its front sides or tips and the adjoining tooth flanks.

It is further proposed here that the thickening has a greater thickness in the region of the radially inwardly directed front sides of the toothing than in the toothing base arranged radially on the outer side.

It is further proposed that the pot-like housing is harder in the region of the thickening and the toothing arranged therein at the edge of the opening than in the region comprising the tensioner drive wheel. Due to the proposed higher hardness, the housing is more dimensionally stable and wear-resistant in the region of the toothing, which is particularly advantageous for the restraining forces to be transmitted and the dimensional stability of the housing as such in the event of restraining.

The hardness of the toothing can preferably decrease radially outwards, so that the toothing is particularly dimensionally stable and wear-resistant, particularly in the region of the tooth tips and the adjoining tooth flanks.

The invention is explained below using preferred embodiments with reference to the accompanying figures, in which:

FIG. 1 shows a detail of a belt retractor according to the invention;

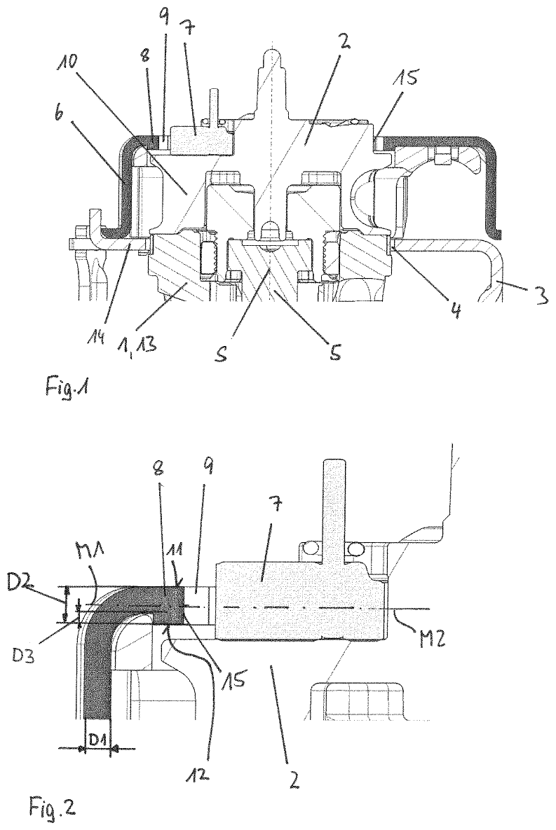

FIG. 2 shows an enlarged detail of FIG. 1 with the blocking pawl and the pot-like housing;

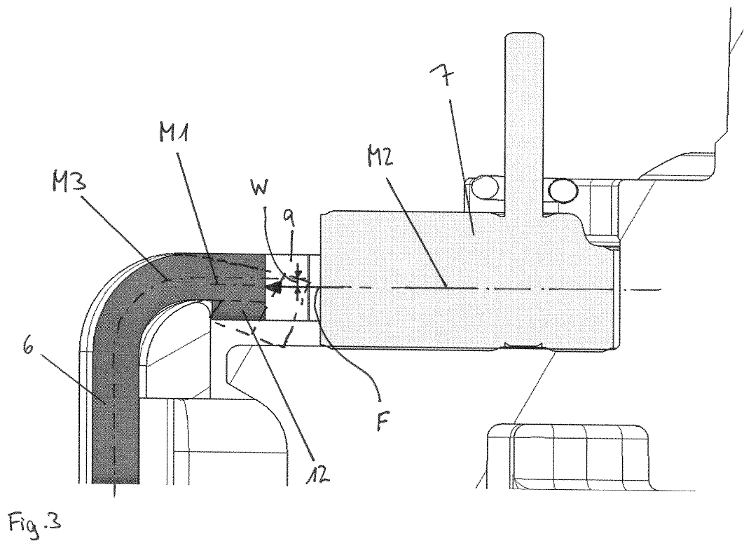

FIG. 3 shows the detail of FIG. 2 in a further enlarged view.

FIG. 1 shows a detail of a belt retractor according to the invention with a frame 3 which can be fixedly fastened to the vehicle and a belt shaft 1 rotatably mounted therein. The frame 3 is U-shaped with two frame legs 14 arranged parallel to each other, of which only one is shown. In each of the frame legs 14 an opening 4 is provided in which the belt shaft 1 is rotatably mounted. The belt shaft 1 is formed in two parts with a belt shaft body 13 and a profile head 2, wherein a safety belt (not shown) can be wound onto the belt shaft body 13. The belt shaft body 13 and the profile head 2 are connected to one another via a torsion bar 5 up to the plastic deformation limit of the torsion bar 5 to form a torsionally fixed connection. The profile head 2 is formed in one piece with a tensioner drive wheel 10 and additionally is a carrier of a blocking pawl 7 pivotally mounted thereon. The tensioner drive wheel 10 has on its outer side a profile consisting of a plurality of calottes arranged one next to the other for engagement of a pyrotechnically driven mass body chain. Depending on the drive type, the tensioner drive wheel 10 can also be a gear or a comparable power-transmitting wheel. Irreversible drives such as pyrotechnic drives or reversible drives such as electric motors are conceivable as drives. Furthermore, a gear can additionally be provided between the drive and the tensioner drive wheel.

On the outer side of the frame leg 14, i.e., on the side of the frame leg 14 facing away from the other frame leg (not shown), a pot-like housing 6 is fastened, which at least in portions encloses the tensioner drive wheel 10. The pot-like housing 6 has an opening 15 through which the profile head 2 passes. The blocking pawl 7 is arranged such that it is pivotally mounted on the portion of the profile head 7 that passes through the opening 15. In the opening 15 of the pot-like housing 6, a toothing 9 is arranged, into which the blocking pawl 7 engages when pivoting out.

The blocking pawl 7 is part of a blocking device which additionally comprises corresponding sensor devices which, depending on the exceeding of a predetermined extension acceleration of the safety belt and/or the exceeding of a predetermined vehicle deceleration in conjunction with a control disc, force the pivoting movement of the blocking pawl 7. In the engagement position of the blocking pawl 7 in the toothing 9 of the pot-like housing 6, the belt shaft 1 is blocked in the extension direction in a known manner, wherein the retaining forces or blocking forces are transmitted from the toothing 9 via the pot-like housing 6, the fastening of the pot-like housing 6 to the frame 3 and finally via the fastening of the frame 3 to the vehicle structure or a vehicle seat into the vehicle structure.

The pot-like housing 6 has a thickening 8 in the region of the edge of the opening 15, in which the toothing 9 is arranged. The thickening 8 is formed by a protrusion 12 on one side which is arranged on the inside of the pot-like housing 6 or, in other words, on the side of the housing 6 directed towards the frame leg 14, while the outer side of the housing 6 in the region of the thickening 8, i.e., on the side facing away from the frame leg 14, is formed by a flat surface 11.

FIG. 2 shows an enlarged detail of the belt retractor with the housing 6 and the blocking pawl 7. The housing 6 has an at least substantially constant wall thickness D1 in the region comprising the tensioner drive wheel 10 and is formed into a thickening 8 with a thickness D2 in the region of the edge of the opening 15. The thickness D2 of the thickening 8 is formed by the housing 6 being thickened by the protrusion 12 in this region by the thickness D3 in addition to the wall thickness D1 of the housing 6. The thickening 8 can be realized, for example, by a forming process of the edge of the opening 15, in a production process of the housing 6 in a stamping process or in a comparable shaping process. The protrusion 12 can be regarded as a kind of bead or cams surrounding the opening 15, which specifically stabilize the edge of the opening 15 under the load that occurs, as will be explained in more detail below.

The thickening 8 is dimensioned such that it has a greater extension in the radial direction with respect to the axis of rotation S of the belt shaft 1 shown in FIG. 1 than the depth of the toothing 9, so that the toothing 9 is arranged completely in the thickening 8. The thickening 8 is deliberately oriented on one side, so that the protrusion 12 is directed towards the inside of the housing 6, while the outer side in this region is formed by the flat surface. Thus, the installation space inside the housing 6 is used to realize the thickening 8, while the outer side is optimized with regard to the installation space requirement by forming the flat surface.

As can be seen in FIG. 3, the protrusion 12 enlarges the force application surface of the toothing 9 towards the inside of the housing 6, so that the force vector F resulting from the total load on the toothing 9 is offset towards the inside of the housing 6. The offset is shown in FIG. 3 by the distance of the force vector F to the neutral fiber or center M3 of the housing 6 in the region without the thickening 8. Due to this displacement of the force vector F caused by the thickening 8 arranged on the inside of the housing, when the blocking pawl 7 engages the toothing 9, a moment is exerted on the edge of the housing 6, which moment is oriented clockwise in the view in FIG. 3 and pushes the edge of the opening 15 inwards into the position shown exaggeratedly in dashed lines in FIG. 3. In this case, a compressive stress is generated in the protrusion 12 arranged on the inside of the housing, which counteracts the deformation and stiffens the housing 6 itself during the deformation, which in turn limits the deformation of the edge.

Due to this force shift of the force vector F, the housing 6 is deformed in the region of the edge of the opening 15 towards the inside of the housing 6 when loaded. This counteracts a tendency for the housing 6 to “expand” towards the outer side when the blocking pawl 7 engages. The displacement of the force vector F can also be recognized in FIG. 3 by the displacement of the center M1 of the housing 6 in the thickening 8 compared to the center M3 of the housing 6 in the region without thickening 8.

Ideally, the thickening 8 is dimensioned or the blocking pawl 7 is arranged in relation to the thickening 8 in such a way that the center M2 of the blocking pawl 7 and the center M1 of the thickening 8 lie in one plane, so that the housing 6 in the region of the toothing 9 and the thickening 8 and the blocking pawl 7 are loaded as evenly as possible.

The thickness D2 of the thickening 8 preferably corresponds to the thickness of the toothing 9, so that the entire cross section of the thickening 8 is used to form the toothing 9.

The thickness D2 of the thickening 8 is preferably increased by at least 20 percent and at most 80 percent compared to the wall thickness D1 of the housing 6. In the present embodiment, the thickness D2 of the thickening 8 is 2 to 2.8 mm and the wall thickness D1 of the housing 6 is 1.75 mm. The thickness D2 of the thickening 8 can decrease in the radial direction. Thus, the thickness D2 in the region of the tips of the toothing 9 can be 2.8 mm, while the thickness D2 in the region of the radially outer tooth base of the toothing 9 can be 2 mm.

Furthermore, the housing 6 has a higher hardness in the region of the thickening 8 and the toothing 9 than in the portion of the housing 6 comprising the tensioner drive wheel 10 without the thickening 8. In particular, the teeth of the toothing 9 have a higher hardness at their tips and adjacent tooth flanks than the thickening in the radially outwardly adjoining portion. This allows the toothing 9 to be designed to be particularly dimensionally stable and wear-resistant.

1. A belt retractor with a tensioning device with
a frame which can be fixed to the vehicle and has two frame legs, arranged parallel to one another, each with a bearing opening, and
a belt shaft which is arranged between frame legs and is rotatably mounted in the bearing openings of the frame legs, and
a tensioner drive wheel which is connected to the belt shaft in a rotationally fixed manner or can be connected via a clutch, wherein
a pot-like housing with a substantially constant wall thickness is fastened to one of the frame legs on the side facing away from the other frame leg, in which the tensioner drive wheel is arranged, wherein
the pot-like housing has an opening with a toothing, and
a pivotally mounted blocking pawl is provided on the belt shaft, which engages the toothing of the opening of the pot-like housing to block the belt shaft in the extension direction, wherein
the pot-like housing has, at least in portions, a thickening in the region of the edge of the opening and the toothing, in which the toothing is arranged, wherein
the thickening is formed by a protrusion on one side which is directed towards the frame leg to which the pot-like housing is fastened, and
the side of the edge of the opening and the toothing facing away from the frame leg is formed by a flat surface.

2. The belt retractor according to claim 1, wherein the thickness of the toothing in the direction of the axis of rotation of the belt shaft corresponds to the thickness of the thickening in the direction of the axis of rotation of the belt shaft.

3. The belt retractor according to claim 1, wherein the thickening is dimensioned such that the center of the toothing that is arranged perpendicularly to the axis of rotation of the belt shaft and extends through the thickening and the center of the blocking pawl that is arranged perpendicularly to the axis of rotation of the belt shaft lie in one plane.

4. The belt retractor according to claim 1, wherein the pot-like housing has a thickness in the region of the thickening which is at least 20 percent and at most 80 percent larger than the wall thickness of the pot-like housing.

5. The belt retractor according to claim 1, wherein the thickening is larger in the radial direction than the toothing depth of the toothing.

6. The belt retractor according to claim 1, wherein the thickness of the thickening decreases outwards in the radial direction.

7. The belt retractor according to claim 6, wherein the thickening has a greater thickness in the region of the radially inwardly directed front sides of the toothing than in the toothing base arranged radially on the outer side.

8. The belt retractor according to claim 1, wherein the pot-like housing is harder in the region of the thickening and the toothing arranged therein at the edge of the opening than in the region comprising the tensioner drive wheel.

9. The belt retractor according to claim 8, wherein the hardness in the toothing-decreases radially outwards.
